(19) United States
(12) Patent Application Publication
(10) Pub. No.: US 2006/0108014 A1
(43) Pub. Date: May 25, 2006

(54) Automotive power steering systems

(76) Inventor: Andrew David Marsh, Woodville North (AU)

Correspondence Address: DEWITT ROSS & STEVENS, S.C.;Intellectual Property Department, Firstar Financial Centre, 8000 Excelsior Drive Suite 401, Madison, WI, 53717-1914, US

(21) Appl. No.: 10/996,143

(22) Filed: Nov. 23, 2004

(51) Int. Cl. F16L 55/027

(52) U.S. Cl. 138/42

(57) ABSTRACT

A device for attenuating shudder in vehicle power steering systems, whereby a baffle tube is positioned in the power steering hydraulic circuit to break up pressure waves which may exist in the system.

### FIELD OF THE INVENTION

This invention relates to improvements in automotive power steering systems, more particularly to modifications to attenuate steering shudder.

### BACKGROUND OF THE INVENTION

Power steering systems are commonly installed in motor vehicles to assist the driver by reducing the effort required to steer the vehicle while still retaining a degree of feel on the steering wheel. The power steering system includes a hydraulic pump to supply fluid under pressure from a reservoir to a control valve which directs the oil to either side of a piston rack piston. The rack is moved by a pinion on the steering column, the rack piston assisting in the movement.

The pump delivers high pressure oil to the control valve through a high pressure line. A low pressure line is connected to the outlet of the control valve, the low pressure line returns the oil to the reservoir through an oil cooler heat exchanger loop.

However, a problem exists in many power steering systems. At the time of sudden steering movements the rapid opening and closing of the control valve creates large pressure pulses and fluctuations in the hydraulic system. This creates shudder in the vehicle and can be quite severe to such an extent the vehicle is un-drivable.

Various attempts have been made to overcome the problem and examples of these are referred to below.

JP 11321681 describes a system whereby the low pressure oil from the control valve passes through the oil cooler to the reservoir. An electromagnetic valve selectively bypasses the oil cooler under the control of sensors detecting the turning of the wheels in a steering movement.

JP 11115782 provides a hydraulic hose adapted for elastic deformation in a radial direction to absorb pressure variations in a power steering system.

JP 53002825 discloses a pair of pistons in a vibration absorbing chamber to prevent chatter phenomenon at the initial time of steering.

JP 10287256 describes a branch line on the lower pressure line from the control valve. The branch line is plugged at its end and consists of material having extensibility to absorb the pressure pulses.

In JP 02274659 the reservoir is divided into two separate chambers. The pump is fed from one chamber, the return from the control valve exhausts into the second chamber. From the second chamber the oil passes through an oil cooler back to the first chamber. The surge pressure from the valve is absorbed in the second chamber.

JP 60143181 and JP 60143182 each describe a reaction chamber which exhibits a damper function to suppress vibration of the valve spool.

U.S. Pat. Nos. 6,119,728, 5,941,283, 5,539,164, 6,338,363, 4,285,534 and 4,794,955 describe various forms of attenuation hoses.

U.S. Pat. No. 4,203,287 describes an expansible chamber in a power steering system.

U.S. Pat. No. 5,193,885 describes a power braking system in which pressure pulsations are absorbed in an accumulator.

### SUMMARY OF THE INVENTION

The invention, which is defined by the claims set forth at the end of this document, is directed to a modification to a power steering system to attenuate steering shudder, more specifically to attenuate fluid borne pulsations that lead to power steering pump noise and shudder. The invention provides an attenuating device positioned in the interior of a line or hose of the power steering circuit to break up pressure waves which may exist in the system. In a preferred form of the invention, the device may comprise a baffle positioned in either the pressure or return lines (i.e., hoses, pipes, or other conduits). The baffle may be positioned in the line such that the entire fluid flow passes through the baffle, or alternately some of the fluid may pass around the outer surface of the baffle. In a preferred version of the invention, the baffle comprises a tube having baffle plates restricting the fluid flow spaced along the tube to interrupt and reflect pressure pulsations. Each baffle plate may be semi-circular, with adjacent baffle plates each being oriented 180 degrees from its adjacent baffle. The baffle may comprise a spiral wound tuner cable within a tube, whereby the fluid can pass not only through the tube, but bypass around the outside of the tube.

Further details regarding preferred versions of the invention may be found in the Detailed Description set forth elsewhere in this document, with the claims set forth at the end of this document defining the various versions of the invention in which exclusive rights are secured.

### BRIEF DESCRIPTION OF THE DRAWINGS

FIG. 1 is a diagrammatic sketch of a typical power steering system.

FIGS. 2a and 2b are views of one form of a baffle exemplifying the invention.

### DETAILED DESCRIPTION OF PREFERRED VERSIONS OF THE INVENTION

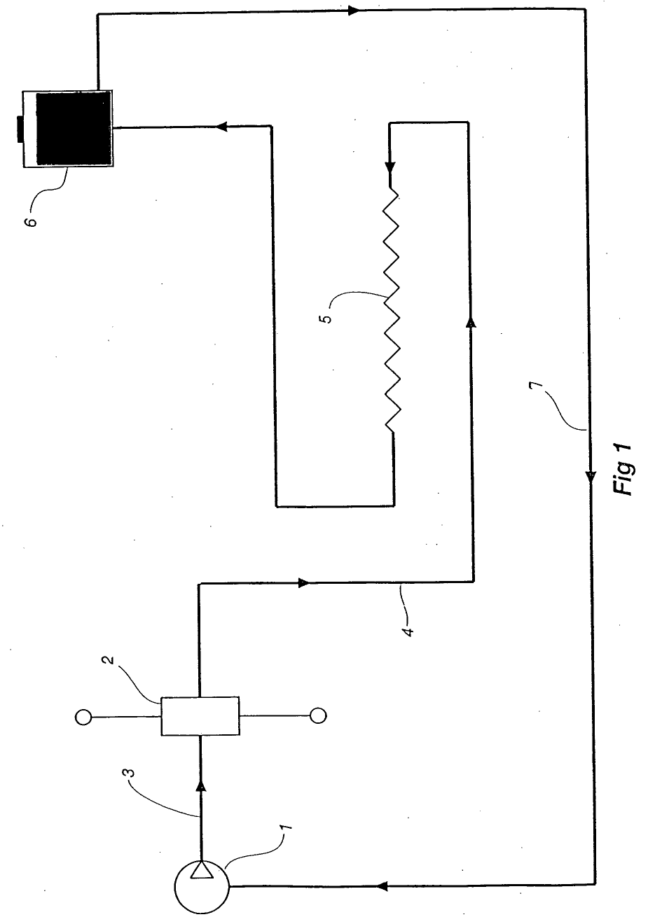

Referring to FIG. 1, the hydraulic pump 1 delivers pressurized fluid to the steering control valve 2 through line 3. The hydraulic fluid then passes through line 4 including an oil cooler 5 back to the oil reservoir 6 supplying the pump through line 7.

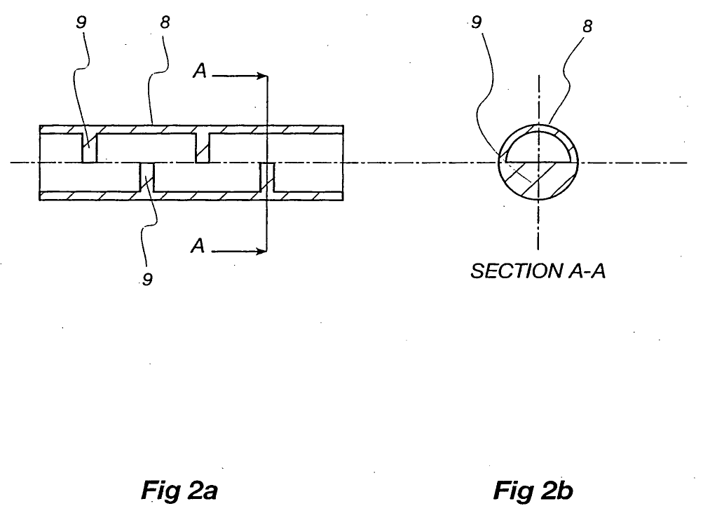

FIG. 2 shows one form of attenuator which exemplifies the invention, in the form of a cylindrical baffle tube 8. In this version the tube has four baffle plates 9, each baffle plate 9 being orientated at 180 degrees. Each baffle plate 9 is semi-circular and thus obstructs one half of the interior of the tube 8. In the illustrated version, there are four baffle plates 9, but it should be understood that other numbers of baffle plates 9 can be used. In the particular installation in which the baffle was tested four baffle plates 9 gave a satisfactory result. Back pressure can increase as the number of baffle plates 9 increases.

The tube 8 can be positioned in either the pressure line 3 or the return line 4, and it should be understood that the tube 8 can be provided as a separate component installed within the lines 3 and 4, or as an integral part of such lines. The baffles 9 may be provided as a spiral wound tuner cable arrangement, with such a cable located within the tube 8 or the pressure or return lines 3 and 4. In this case, the cable may define a spiral path having a length which continuously protrudes into the line, or alternatively the baffles 9 may be provided as members spaced along the cable such that they protrude into the line at spaced intervals. Other structures apart from a cable (or surrounding tube), e.g., rods, bars, or other bridging members, could instead be used to connect the baffles 9 into a unitary baffle unit suitable for installation. In this instance the baffles 9 may be installed such that fluid not only passes through the baffles 9 but provides also a fluid path around the outside of the baffles 9. Alternately the baffles 9 can be clamped into the tube 8 or lines 3 and 4 allowing fluid to pass only through the baffles 9.

Thus there has been described an attenuation device in the form of a baffle tube 8 inserted in the hydraulic circuit of a power steering system. The invention is not intended to be limited to the preferred versions described above, but rather is intended to be limited only by the claims set out below. Thus, the invention encompasses all different versions that fall literally or equivalently within the scope of these claims.

What is claimed is:

1. A device for attenuating shudder in vehicle power steering systems, the device being positioned in the interior of a line of the power steering hydraulic circuit to break up pressure waves which may exist in the line.

2. The device for attenuating shudder in vehicle power steering systems of claim 1, wherein the device comprises a tube having at least one baffle situated therein, the tube being positioned in one of:
a. a pressure line of the power steering hydraulic circuit; or
b. a return line of the power steering hydraulic circuit.

3. The device for attenuating shudder in vehicle power steering systems of claim 2, wherein the tube is positioned in the line such that the entire fluid flow through the line passes through the baffle.

4. The device for attenuating shudder in vehicle power steering systems of claim 3, wherein the tube has multiple baffles therein.

5. The device for attenuating shudder in vehicle power steering systems of claim 4 wherein each baffle is semicircular, with each baffle plate being oriented 180 degrees from any adjacent baffle.

6. The device for attenuating shudder in vehicle power steering systems of claim 2, wherein the tube is positioned in the line such that some of the fluid flow within the line passes around the outer surface of the baffle.

7. The device for attenuating shudder in vehicle power steering systems of claim 6, wherein the tube has multiple baffles therein.

8. The device for attenuating shudder in vehicle power steering systems of claim 7 wherein each baffle is semicircular, with each baffle plate being oriented 180 degrees from any adjacent baffle.

9. The device for attenuating shudder in vehicle power steering systems of claim 1 wherein the device includes a cable with baffles situated thereon, the cable being wound within a line of the power steering hydraulic circuit such that the baffles are spaced along the line.

10. A device for attenuating shudder in vehicle power steering systems, the device comprising a series of baffles protruding into a line of a power steering hydraulic circuit to break up pressure waves which may exist in the line.

11. The device for attenuating shudder in vehicle power steering systems of claim 10, wherein the baffles are situated within the interior of a tube fit within the line.

12. The device for attenuating shudder in vehicle power steering systems of claim 10, wherein the baffles are defined on a cable spirally wound within the interior of the line.

13. The device for attenuating shudder in vehicle power steering systems of claim 10, wherein the baffles are spaced along the length of the line.

14. The device for attenuating shudder in vehicle power steering systems of claim 13, wherein each baffle is offset with respect to any adjacent baffles about the circumference of the line.

15. The device for attenuating shudder in vehicle power steering systems of claim 14, wherein each baffle is offset by 180 degrees with respect to any adjacent baffles about the circumference of the line.

16. The device for attenuating shudder in vehicle power steering systems of claim 15, wherein the baffles are semicircular.

17. The device for attenuating shudder in vehicle power steering systems of claim 10, wherein the baffles are provided on a cable spirally wound within the interior of the line.

18. A device for attenuating shudder in vehicle power steering systems, the device comprising a series of spaced baffles protruding into a line of a power steering hydraulic circuit to break up pressure waves which may exist in the line, each baffle extending from a different arc of the circumference of the line than any adjacent baffles.

19. The device for attenuating shudder in vehicle power steering systems of claim 18, wherein each baffle extends from an arc of the circumference of the line which is offset 180 degrees from any adjacent baffles.

20. The device for attenuating shudder in vehicle power steering systems of claim 18, wherein the baffles are oriented parallel to each other.
